(19) United States
(12) Patent Application Publication
(10) Pub. No.: US 2007/0164747 A1
(43) Pub. Date: Jul. 19, 2007

(54) Method and apparatus for simulating electrostatic discharge events in manufacturing and calibrating monitoring equipment

(75) Inventor: Timothy J. Maloney, Palo Alto, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/317,755

(22) Filed: Dec. 23, 2005

(51) Int. Cl. F02P 17/00

(52) U.S. Cl. 324/382

(57) ABSTRACT

In some embodiments, a method and apparatus for simulating electrostatic discharge events in manufacturing and calibrating monitoring equipment are presented. In this regard, a device is introduced to simulate an ESD event by discharging a stored charge and measuring in situ the quantity of charge discharged. Other embodiments are also disclosed and claimed.

### FIELD OF THE INVENTION

Embodiments of the present invention generally relate to the field of electronic devices, and, more particularly to a method and apparatus for simulating electrostatic discharge events in manufacturing and calibrating monitoring equipment.

### BACKGROUND OF THE INVENTION

When electrostatic discharge (ESD) events in electronic equipment are caused by the socketing or handling of a charged component, the high frequency electromagnetic oscillation of the local ground plane (from which the balancing charge is extracted) can be picked up by a nearby antenna. FIG. 1 is an example of an oscillatory scope waveform resulting from electromagnetic interference (EMI) antenna near a charged device model (CDM) ESD event. Monitoring these signals is typically part of a static control program in an integrated circuit assembly factory. There is a need, however, for knowing the physical properties of these events (particularly the quantity of the suddenly injected charge) so that component test data for the CDM of electrostatic discharge can be related and that factory personnel can produce a CDM-EMI event at will and calibrate the antennas.

### BRIEF DESCRIPTION OF THE DRAWINGS

The present invention is illustrated by way of example and not limitation in the figures of the accompanying drawings in which like references indicate similar elements, and in which:

FIG. 1 is an example of an oscillatory scope waveform resulting from EMI antenna near a CDM ESD event, in accordance with one example embodiment of the invention;

FIG. 2 is a block diagram of an example system for simulating electrostatic discharge events, in accordance with one example embodiment of the invention;

FIG. 3 is a block diagram of another example system for simulating electrostatic discharge events, in accordance with one example embodiment of the invention; and

FIG. 4 is a flow chart of an example method for simulating electrostatic discharge events in manufacturing and calibrating monitoring equipment, in accordance with one example embodiment of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

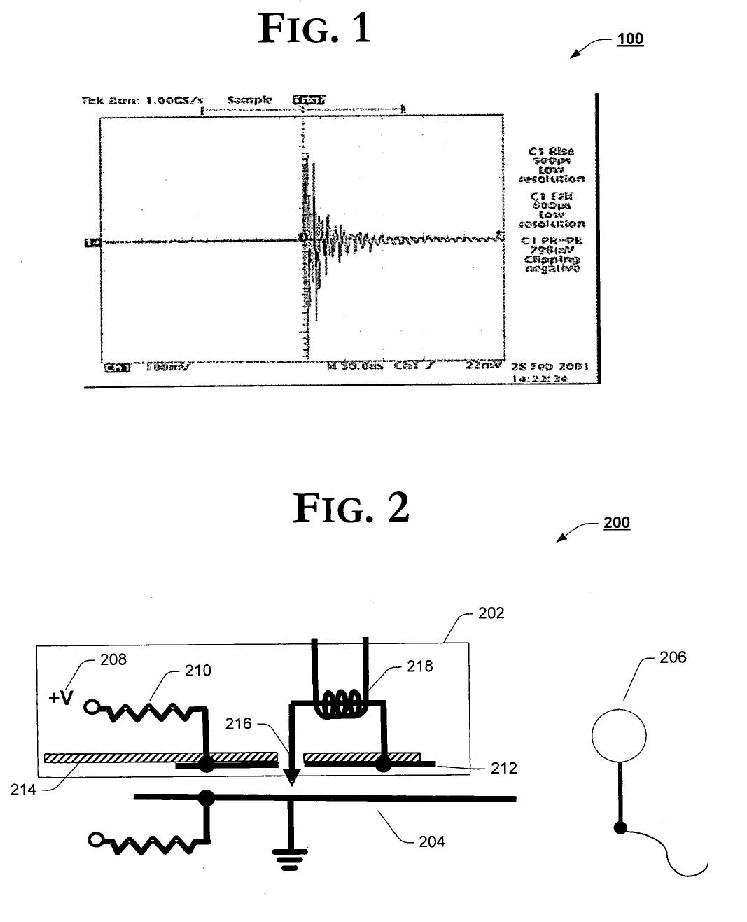

FIG. 2 is a block diagram of an example system for simulating electrostatic discharge events, in accordance with one example embodiment of the invention. In accordance with the illustrated example embodiment, system 200 may include one or more of discharge device 202, ground plane 204 and EMI antenna 206 coupled as shown in FIG. 2. Discharge device 202 may include voltage source 208, isolating resistor 210, charge storage 212, insulating paddle 214, discharge wire 216 and current probe 218.

Discharge device 202 may have the ability to simulate CDM ESD events. Voltage source 208 provides the charge. In one embodiment, voltage source 208 may vary between about 25 and 75 Volts to develop an understanding of how the amount of charge relates to the EMI measurements. Isolating resistor 210 is a high resistance resistor which isolates the charged elements of discharge device 202 from voltage source 208. In one embodiment, isolating resistor 210 is a 1 mega-ohm resistor. Charge storage 212 holds the charge until discharge occurs. In one embodiment, charge storage 212 is a plate of metal of about 4 cm square. Insulating paddle 214 may provide a safe means of handling discharge device 202. In one embodiment, insulating paddle 214 is a handle of a manufacturing device, such as a vacuum wand. Discharge wire 216 carries the charge from charge storage plate 212 to an external surface such as ground plane 204. As shown, discharge wire 216 protrudes out through charge storage plate 212 creating a peg, however the protrusion is minimized to avoid the effects of the radiated dipole moment during discharge. In one embodiment, discharge wire 216 protrudes beyond charge storage 212 about 6 mm. Current probe 218 may provide a means to measure in situ the current discharged and therefore determine the amount of charge discharged. In one embodiment, current probe 218 is a Tektronix CT1 current probe connected to an oscilloscope with a waveform integrating function

Ground plane 204 represents a grounded surface to receive a discharge from device 202. In one embodiment, ground plane 204 is a socket in an assembly test factory. Ground plane 204 may also be coupled with voltage source 208 through an isolating resistor.

EMI antenna 206 may be located near ground plane 204 to detect radiated voltages. The distance of EMI antenna 206 from ground plane 204 may be varied to determine the effects on EMI measured as part of a calibration process, for example as described in reference to FIG. 4. In some embodiments, the distance from EMI antenna 206 to ground plane 204 varies from about 15-30 cm. EMI antenna 206 may be connected to the same oscilloscope as current probe 218. In this way, a two-channel oscilloscope may be able to correlate the amount of charge to the EMI peak-to-peak voltage.

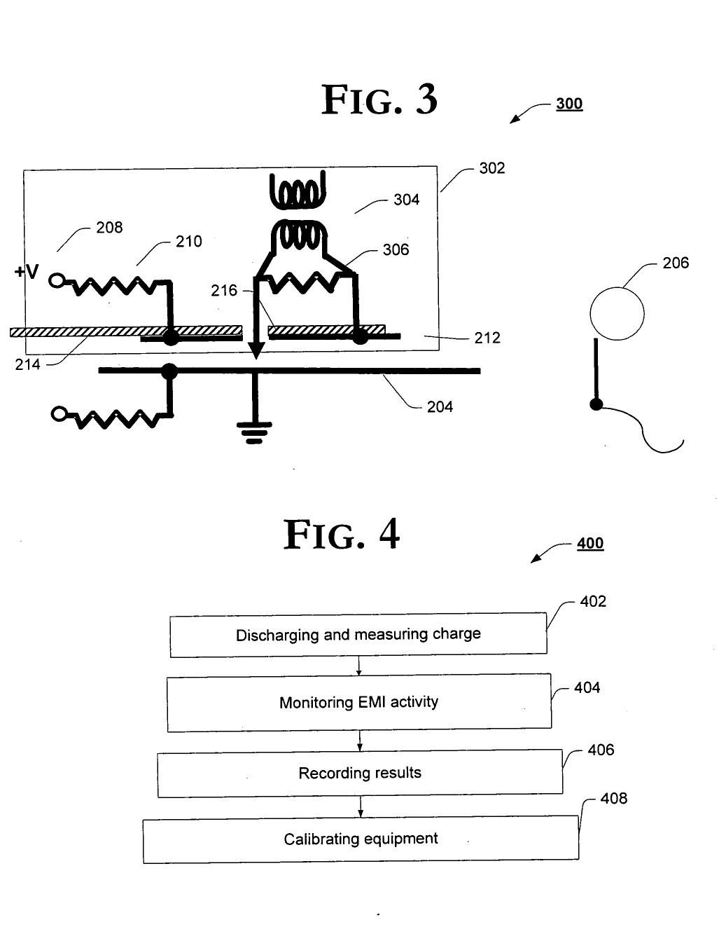

FIG. 3 is a block diagram of an example system for simulating electrostatic discharge events, in accordance with one example embodiment of the invention. In accordance with the illustrated example embodiment, system 300 may include one or more of discharge device 302, ground plane 204 and EMI antenna 206 coupled as shown in FIG. 3. Discharge device 302 may include voltage source 208, isolating resistor 210, charge storage 212, insulating paddle 214, discharge wire 216, transformer 304 and drain resistor 306.

Discharge device 302 differs from discharge device 202 in the circuitry to measure in situ the current discharged. Current probe 218 may add several picofarads to the total capacitance being discharged. Alternate embodiment discharge device 302 includes transformer 304 which may be connected to the oscilloscope through a coax cable. The value of drain resistor 306 may be varied based on the coax cable impedance and transformer performance. In one embodiment, with a 50 ohm coax, drain resistor 306 is a 5 ohm resistor and transformer turns ratio is 1:1. In another embodiment, the value of drain resistor 306 is a z-match to the coax cable when the transformer turns ratio is considered.

FIG. 4 is a flow chart of an example method for simulating electrostatic discharge events in manufacturing and calibrating monitoring equipment, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 4 begins with discharging and measuring (402) charge. Discharge occurs when discharge wire 216 is brought near ground plane 204. The charge is measured through current probe 218 or transformer 304. Voltage source 208 may be varied to provide a range of results.

Also at the time of discharge, a two-channel oscilloscope will be monitoring (404) EMI activity from EMI antenna 206. In this way, charge (Q) can be correlated to peak-to-peak voltage (Vₚ₋ₚ). The distance of EMI antenna 206 from ground plane 204 is varied to provide calibration data.

The results are recorded (406) from various combinations and permutations of variables. A database can be developed that correlates all the factors to develop a model of CDM ESD events.

Lastly, the results can be used to calibrate (408) equipment. In this way a given setup of antenna and equipment can be calibrated so that when an EMI Vₚ₋ₚ is measured with the antenna, it would be possible to determine the size of the charge packet.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
discharging a stored charge to a ground plate that is in range of an EMI antenna; and
measuring in situ the quantity of charge discharged.

2. The method of claim 1, wherein measuring charge quantity in situ comprises measuring current in situ.

3. The method of claim 1, further comprising monitoring EMI through an oscilloscope coupled with the EMI antenna.

4. The method of claim 3, further comprising recording results obtained by the oscilloscope.

5. The method of claim 4, further comprising calibrating equipment to detect an ESD event based on the recorded results.

6. An apparatus, comprising:
a voltage source;
a charge storage electrically coupled to the voltage source;
a peg to discharge a stored charge; and
circuitry to measure in situ the quantity of charge discharged.

7. The apparatus of claim 6, further comprising an insulating paddle.

8. The apparatus of claim 6, wherein the charge storage comprises a metal plate.

9. The apparatus of claim 6, wherein the circuitry to measure the quantity of charge discharged comprises a current probe connected to an oscilloscope.

10. The apparatus of claim 6, wherein the circuitry to measure the quantity of charge discharged comprises a transformer and cable connected to an oscilloscope.

11. A system comprising:
a platform containing a ground plate;
an antenna to measure electrostatic events at the platform; and
an instrument charged to a known voltage to discharge a charge to the ground plate which is measurable in situ.

12. The system of claim 11, wherein the quantity of charge discharged is measured by an oscilloscope based on a current measurement.

13. The system of claim 12, wherein the current measurement is obtained through a transformer coupled with a wire through which the charge is discharged.

14. The system of claim 12, wherein the antenna is coupled with the oscilloscope.

15. The system of claim 12, wherein the current measurement is obtained through a current probe coupled with a wire through which the charge is discharged.
